(19) United States
(12) Patent Application Publication
(10) Pub. No.: US 2017/0190876 A1
(43) Pub. Date: Jul. 6, 2017

(54) FAST CURING, TRANSPARENT AND TRANSLUCENT, NON-HALOGENATED FLAME RETARDANT SYSTEMS

(71) Applicant: FRX Polymers, Inc., Chelmsford, MA (US)

(72) Inventors: Lawino KAGUMBA, Cambridge, MA (US); Morgan PILKENTON, Somerville, MA (US)

(21) Appl. No.: 15/395,354

(22) Filed: Dec. 30, 2016

Related U.S. Application Data
(60) Provisional application No. 62/273,627, filed on Dec. 31, 2015.

(51) Int. Cl. C08K 5/521; C08K 3/22; C08K 5/52; C08G 63/91; C08K 5/524

(52) U.S. Cl. CPC C08K 5/521; C08G 63/916; C08K 5/524; C08K 5/5205; C08K 3/22; C08K 2003/2227; C08K 2201/003

(57) ABSTRACT

Methods for curing unsaturated polyesters or vinyl esters in compositions that include oligomeric phosphonates, and combinations thereof and compositions and cured polymers made by these methods are described herein.

### CROSS-REFERENCE TO RELATED APPLICATIONS

This application claims priority to U.S. Provisional Application No. 62/273,627 entitled, “Fast Curing, Transparent, Non-Halogenated Flame Retardant Systems” filed Dec. 31, 2015, which is hereby incorporated by reference in its entirety.

### GOVERNMENT INTERESTS

Not applicable

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

Unsaturated polyester resins are typically cured using organic peroxide systems in combination with a cobalt promoter. At room temperature, these resin compositions gel in under ten minutes in the presence of organic peroxides like methyl ethyl ketone peroxide (MEK-P). Compositions containing oligomeric phosphonates do not readily gel at room temperature when equivalent levels of cobalt and peroxide systems are used. As a result, the materials cure slowly and remain sticky, making removal from molds difficult.

### A. SUMMARY OF THE INVENTION

Various embodiments include a cured polymer containing an unsaturated polyester, an oligomeric phosphonate, and a cobalt containing curing agent. In some embodiments, the unsaturated polyester may be any of ortho-resins based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins prepared from isophthalic acid, maleic anhydride or fumaric acid, and glycols, bisphenol-A-fumarates derived from bisphenol-A and fumaric acid, chlorendics prepared from chlorine/bromine containing anhydrides or phenols, and vinyl ester resins, vinyl ester which can be prepared from epoxy resins such as, for example, diglycidyl ether of bisphenol-A, epoxies of the phenol-novolac type, or epoxies based on tetrabromobisphenol-A reacted with (meth)acrylic acid or acrylamide monomers.

In certain embodiments, the oligomeric phosphonate contain structural units of Formula I:

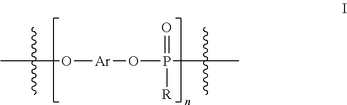

wherein Ar is an aromatic group; R is C₁₋₂₀ alkyl, C₂₋₂₀ alkene, C₂₋₂₀ alkyne, C₅₋₂₀ cycloalkyl, or C₆₋₂₀ aryl; and n is an integer from 1 to about 20. In some embodiments, —O—Ar—O— in the structure above may be derived from a dihydroxy compound selected from the group consisting of resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof. In particular embodiments, the oligomeric phosphonate may have a weight average molecular weight (Mw) of about 1,000 g/mole to about 18,000 g/mole as determined by GPC, and in some embodiments, the oligomeric phosphonate may have a number average molecular weight (Mn) in such embodiments may be from about 500 g/mole to about 10,000 g/mole. In certain embodiments, the oligomeric phosphonate may have a molecular weight distribution (Mw/Mn) of about 2 to about 7. In some embodiments, the oligomeric phosphonate may have a phosphorous content of about 2% to about 10% by weight of the total cured polymer. In some embodiments, the oligomeric phosphonate may be any of random co-oligo(phosphonate carbonate)s, co-oligo(phosphonate carbonate)s, co-oligo(phosphonate carbonate)s, co-oligo(phosphonate ester)s, and combinations thereof.

In various embodiments, the cobalt containing curing agent may be any of cobalt octoate, cobalt 2-ethylhexanoate, cobalt naphthenate, cobalt acetylacetonate, and combinations thereof. In some embodiments, the cured polymer may further include a transition metal curing agent such as, for example, lead naphthenate, manganese naphthenate, manganese octoate, manganic acetylacetonate, zinc octoate, zinc naphthenate, zinc acetylacetonate, copper acetylacetonate, cupric naphthenate, nickel acetylacetonate, titanyl acetylacetonate, ferric octoate, tin octoate, vanadium(IV) acetylacetonate, vanadium(V) acetylacetonate, and combinations thereof. In some embodiments, the cured polymer may further include an organic peroxide such as, for example, tertiary alkyl hydroperoxides, t-butyl hydroperoxide), hydroperoxides, cumene hydroperoxide, ketone peroxides, methyl ethyl ketone peroxide, methyl isobutyl ketone peroxide, and acetylacetone peroxide, peroxyesters, peracids, t-butyl peresters, benzoyl peroxide, peracetates, perbenzoates, lauryl peroxide, (di)peroxyesters, -perethers, peroxy diethyl ether, tertiary peresters, tertiary hydroperoxides, peroxy compounds having tertiary carbon atoms directly united to an —OO-acyl or —OOH group, and combinations thereof. In some embodiments, the cured polymer may further include a co-promoter such as, for example, N,N-dimethylaniline, N,N-dimethylacetoacetamide, N,N-diethylaniline acetoacetanilide, N-phenyldiethoanolamine, N,N-diisopropylidine-p-toluidine, N,N-dimethyl-p-toluidine, N,N-diisopropylol-p-toluidine, N,N-diethylol-p-toluidine, N-bis(2-hydroxyethyl)-xylidine, ethyl acetoacetate, methyl acetoacetate, and combinations thereof.

In various embodiments, the cured polymer may have a light transmission percentage greater than 80% for a 4.6 mm thickness sample. In some embodiments, the cured polymer may have a light transmission percentage greater than 70% for a 1 thickness sample. In certain embodiments, the cured polymer may have a light transmission percentage greater than 3% for a 3.0 mm sample.

Other embodiments include a method for producing a cured polymer including the steps of combining an unsaturated polyester, oligomeric phosphonate, a cobalt curing agent, and co-promoter to form a reaction mixture; and curing the reaction mixture at about 25° C. In some embodiments, the method may have a gel time of less than 10 minutes. In various embodiments, the unsaturated polyester may be any of the unsaturated polyesters described above. In various embodiments, the oligomeric phosphonate may be any of the oligomeric phosphonates encompassed by Formula I and including the properties including weight average molecular weight (Mw), number average molecular weight (Mn), molecular weight distribution (Mw/Mn), and phosphorous content described above. In certain embodiments, the oligomeric phosphonate may be any of random co-oligo(phosphonate carbonate)s, co-oligo(phosphonate carbonate)s, co-oligo(phosphonate carbonate)s, and co-oligo(phosphonate ester)s. In various embodiments, the cobalt containing curing agent may be any of the cobalt containing curing agents discussed above. In some embodiments, the reaction mixture may further include any of the transition metal curing agents and/or organic peroxides discussed above. In some embodiments, the reaction mixture may further include a co-promoter such as, for example, N,N-dimethylaniline, N,N-dimethylacetoacetamide, N,N-diethylaniline acetoacetanilide, N-phenyldiethoanolamine, N,N-diisopropylidine-p-toluidine, N,N-dimethyl-p-toluidine, N,N-diisopropylol-p-toluidine, N,N-diethylol-p-toluidine, N-bis(2-hydroxyethyl)-xylidine, ethyl acetoacetate, methyl acetoacetate, and combinations thereof, and in some embodiments, the reaction mixture may further include a co-accelerator such as, for example, potassium oxide, potassium hydroxide, potassium C₆-C₂₀ carboxylate, potassium C₆-C₂₀ carbonate, potassium C₆-C₂₀ hydrocarbonate, and combinations thereof. In various embodiments, the molar ratio of cobalt-containing promoter and the co-accelerator may be about 40:1 to about 1:3000. In certain embodiments, potassium carboxylate may be formed in-situ.

Further embodiments include a composition containing an unsaturated polyester, oligomeric phosphonate, and liquid flame retardant. In various embodiments, the unsaturated polyester may be any of the unsaturated polyesters described above. In various embodiments, the oligomeric phosphonate may be any of the oligomeric phosphonates encompassed by Formula I and including the properties including weight average molecular weight (Mw), number average molecular weight (Mn), molecular weight distribution (Mw/Mn), and phosphorous content described above. In certain embodiments, the oligomeric phosphonate may be any of random co-oligo(phosphonate carbonate)s, co-oligo(phosphonate carbonate)s, co-oligo(phosphonate carbonate)s, and co-oligo(phosphonate ester)s. In some embodiments, the liquid flame retardant may be any of resorcinol bis(diphenyl phosphate), triethyl phosphate (TEP), vinylphosphonic acid dimethyl ester (VPAME), low molecular weight liquid phosphonates, (5-Ethyl-2-methyl-1,3,2-dioxaphosphorinan-5-yl)methyl dimethyl phosphonate P-oxide, and diphenyl methylphosphonate (DPP), and combinations thereof. In certain embodiments, the liquid flame retardant may have a concentration of 0.5 wt. % to about 15 wt. %. In various embodiments, the composition may have a light transmission percentage greater than 80% for a 3 mm thickness sample, a light transmission percentage greater than 70% for a 3 mm thickness sample, or a light transmission percentage greater than 3% for a 3 mm thickness sample.

Other embodiments include a composition comprising an unsaturated polyester, oligomeric phosphonate, and filler flame retardant. In various embodiments, the unsaturated polyester may be any of the unsaturated polyesters described above. In various embodiments, the oligomeric phosphonate may be any of the oligomeric phosphonates encompassed by Formula I and including the properties including weight average molecular weight (Mw), number average molecular weight (Mn), molecular weight distribution (Mw/Mn), and phosphorous content described above. In certain embodiments, the oligomeric phosphonate may be any of random co-oligo(phosphonate carbonate)s, co-oligo(phosphonate carbonate)s, co-oligo(phosphonate carbonate)s, and co-oligo(phosphonate ester)s. In certain embodiments, the filler flame retardants may be any of Ammonium Polyphosphate (APP), Melamine Polyphosphate (MPP), Aluminum trihydrate (ATH), Aflammit® PCO900 from Thor Specialties, Inc., and combinations thereof. In particular embodiments, the filler flame retardant may be less than 20% of the composition, and in some embodiments, the composition may have a light transmission percentage greater than 70% for a 3 mm thickness sample.

### DESCRIPTION OF THE DRAWINGS

Not applicable

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

The term “aromatic diol” is meant to encompass any aromatic or predominately aromatic compound with at least two associated hydroxyl substitutions. In certain embodiments, the aromatic diol may have two or more phenolic hydroxyl groups. Examples of aromatic diols include, but are not limited to, 4,4′-dihydroxybiphenyl, hydroquinone, resorcinol, methyl hydroquinone, chlorohydroquinone, acetoxyhydroquinone, nitrohydroquinone, 1,4-dihydroxynaphthalene, 1,5-dihydroxynaphthalene, 1,6-dihydroxynaphthalene, 2,6-dihydroxynaphthalene, 2,7-dihydroxynaphthalene, 2,2-bis(4-hydroxyphenyl)propane, 2,2-bis(4-hydroxy-3,5-dimethylphenyl)propane, 2,2-bis(4-hydroxy-3,5-dichlorophenyl)propane, 2,2-bis(4-hydroxy-3-methylphenyl)propane, 2,2-bis(4-hydroxy-3-chlorophenyl)propane, bis(4-hydroxyphenyl)methane, bis(4-hydroxy-3,5-dimethylphenyl)methane, bis(4-hydroxy-3,5-dichlorophenyl)methane, bis(4-hydroxy-3,5-dibromophenyl)methane, bis(4-hydroxy-3-methylphenyl)methane, bis(4-hydroxy-3-chlorophenyl)methane, 1,1-bis(4-hydroxyphenyl)cyclohexane, bis(4-hydroxyphenyl)ketone, bis(4-hydroxy-3,5-dimethylphenyl)ketone, bis(4-hydroxy-3,5-dichlorophenyl)ketone, bis(4-hydroxyphenyl) sulfide bis(4-hydroxyphenyl) sulfone, phenolphthalein or phenolphthalein derivatives, 4,4′-thiodiphenol, 4,4′-sulfonyldiphenol, 4,4,-dihydroxydiphenylether, and 1,1-bis-(4-hydroxyphenyl)-3,3,5-trimethylcyclohexane. In some embodiments, a single aromatic diol may be used, and in other embodiments, various combinations of such aromatic diols may be incorporated into the polyester.

The term “alkyl” or “alkyl group” refers to a branched or unbranched hydrocarbon or group of 1 to 20 carbon atoms, such as but not limited to methyl, ethyl, n-propyl, isopropyl, n-butyl, isobutyl, t-butyl, octyl, decyl, tetradecyl, hexadecyl, eicosyl, tetracosyl and the like. “Cycloalkyl” or “cycloalkyl groups” are branched or unbranched hydrocarbons in which all or some of the carbons are arranged in a ring such as but not limited to cyclopentyl, cyclohexyl, methylcyclohexyl and the like. The term “lower alkyl” includes an alkyl group of 1 to 10 carbon atoms.

The term “aryl” or “aryl group” refers to monovalent aromatic hydrocarbon radicals or groups consisting of one or more fused rings in which at least one ring is aromatic in nature. Aryls may include but are not limited to phenyl, napthyl, biphenyl ring systems and the like. The aryl group may be unsubstituted or substituted with a variety of substituents including but not limited to alkyl, alkenyl, halide, benzylic, alkyl or aromatic ether, nitro, cyano, and the like and combinations thereof.

“Substituent” refers to a molecular group that replaces a hydrogen in a compound and may include but is not limited to trifluoromethyl, nitro, cyano, C₁-C₂₀ alkyl, aromatic or aryl, halide (F, Cl, Br, I), C₁-C₂₀ alkyl ether, C₁-C₂₀ alkyl ester, benzyl halide, benzyl ether, aromatic or aryl ether, hydroxy, alkoxy, amino, alkylamino (—NHR′), dialkylamino (—NR′R″) or other groups which do not interfere with the formation of the intended product.

As defined herein, an “arylol” or an “arylol group” is an aryl group with a hydroxyl, OH substituent on the aryl ring. Non-limiting examples of an arylol are phenol, naphthol, and the like. A wide variety of arlyols may be used in the embodiments of the invention and are commercially available.

As used herein, the term “about” means plus or minus 10% of the numerical value of the number with which it is being used. Therefore, about 50% means in the range of 45%-55%.

A “flame retardant” refers to any compound that inhibits, prevents, or reduces the spread of fire.

The terms “flame retardant,” “flame resistant,” “fire resistant,” or “fire resistance,” as used herein, can mean that the composition exhibits a limiting oxygen index (LOI) of at least 27. “Flame retardant,” “flame resistant,” “fire resistant,” or “fire resistance” may also refer to the flame reference standard ASTM D6413-99 for textile compositions, flame persistent test NF P 92-504, and similar standards for flame resistant fibers and textiles. Fire resistance may also be tested by measuring the after-burning time in accordance with the UL test (Subject 94). In this test, the tested materials are given classifications of UL-94 V-0, UL-94 V-1 and UL-94 V-2 on the basis of the results obtained with the ten test specimens. Briefly, the criteria for each of these UL-94-V-classifications are as follows:

UL-94 V-0: the maximum burning time after removal of the ignition flame should not exceed 10 seconds and the total burning time (t1+t2) for five tested specimens should not exceed 50 seconds. None of the test specimens should release any drips which ignite absorbent cotton wool.

UL-94 V-1: the maximum burning time after removal of the ignition flame should not exceed 30 seconds and the total burning time (t1+t2) for five tested specimens should not exceed 250 seconds. None of the test specimens should release any drips which ignite absorbent cotton wool.

UL-94 V-2: the maximum burning time after removal of the ignition flame should not exceed 30 seconds and the total burning time (t1+t2) for five tested specimens should not exceed 250 seconds. The test specimens may release flaming particles, which ignite absorbent cotton wool.

Fire resistance may also be tested by measuring after-burning time. These test methods provide a laboratory test procedure for measuring and comparing the surface flammability of materials when exposed to a prescribed level of radiant heat energy to measure the surface flammability of materials when exposed to fire. The test is conducted using small specimens that are representative, to the extent possible, of the material or assembly being evaluated. The rate at which flames travel along surfaces depends upon the physical and thermal properties of the material, product or assembly under test, the specimen mounting method and orientation, the type and level of fire or heat exposure, the availability of air, and properties of the surrounding enclosure. If different test conditions are substituted or the end-use conditions are changed, it may not always be possible by or from this test to predict changes in the fire-test-response characteristics measured. Therefore, the results are valid only for the fire test exposure conditions described in this procedure.

Fire resistance may also be tested by measuring heat release properties. These test methods measure heat release rate as a function of time and report total heat release rate, peak heat release rate, ignition time, but also CO, CO₂, and smoke release. An improved fire resistance would mean an increase in ignition time or a reduction in one or more of these other variables.

The state-of-the-art approach to rendering polymers flame retardant is to use additives such as brominated compounds or compounds containing aluminum and/or phosphorus. Some of these compounds are toxic, and can leach into the environment over time, making their use less desirable. In some countries, certain brominated additives are being phased out of use because of environmental concerns.

The term “toughness,” as used herein, is meant to imply that the material is resistant to breaking or fracturing when stressed or impacted. There are a variety of standardized tests available to determine the toughness of a material. Generally, toughness is determined qualitatively using a film or a molded specimen.

“Number averaged molecular weight” can be determined by relative viscosity (ηᵣₑₗ) and/or gel permeation chromatography (GPC). Unless otherwise indicated, the values recited are based on polystyrene standards. GPC is a type of chromatography that separates polymers by size. This technique provides information about the molecular weight and molecular weight distribution of the polymer, i.e., the polydispersity index (PDI). Low molecular weight may cause mechanical properties such as strength and toughness to be worse compared to higher molecular weight samples of the same polymers.

Various embodiments of the invention are directed to methods for producing flame retardant polyester resins that provide improved processing at room temperature (via significant reduction of gel times). In such embodiments, cobalt containing curing agents and co-promoters are used in combination with organic peroxides. Such methods produce unsaturated polyester systems containing oligomeric phosphonates with improved gel times (less than 10 minutes) and excellent clarity and transparency. Further embodiments are directed to compositions containing polyester resins, oligomeric phosphonates, and liquid flame retardants that exhibit improved clarity and transparency and good viscosity, while providing improved flame retardancy over similar compositions with higher phosphorous content.

The methods of various embodiments may include the steps of combining unsaturated polyester (UPET) and an oligomeric phosphonate to form a reaction mixture, introducing a cobalt containing curing agent, co-promoter, and an organic peroxide to the mixture, and curing the reaction mixture. In some embodiments, curing can be carried out at room temperature. In particular embodiments, the mixture may further include a reactive solvent such as styrene, and in some embodiments, the method may include the step of dissolving the oligomeric phosphonate in a reactive solvent before combining the oligomeric phosphonate with the unsaturated polyester. In such embodiments, curing may occur at room temperature (about 20° C. to about 25° C.) within about 60 minutes, about 30 minutes, or about 20 minutes and in certain embodiments, about 15 minutes or less after combining the components of the mixture.

The concentration of oligomeric phosphonate in the mixture may be up to about 30% or about 40% by weight. For example, in various embodiments, the weight concentration of oligomeric phosphonate may be from about 10% to about 40%, about 15% to about 35%, about 20% to about 35%, or any individual value or range encompassed by these example ranges.

When dissolved in a reactive solvent, the weight concentration of oligomeric phosphonate may be up to about 50% or about 60% in the reactive solvent, oligomeric phosphonate mixture before being combined with UPET to provide sufficient oligomeric phosphonate to produce a final concentration of oligomeric phosphonate of up to about 30% or about 40% by weight as described above. Examples of reactive solvents include α-methylstyrene, (meth)acrylates, N-vinylpyrrolidone, and N-vinylcaprolactam, and in particular embodiments, the reactive solvent may be styrene. The weight concentration of oligomeric phosphonate in the reactive solvent, oligomeric phosphonate mixture may be about 20% to about 60%, about 25% to about 50%, about 30% to about 45% or any range or individual concentration or range encompassed by these example ranges.

In some embodiments, the solution of dissolved oligomeric phosphonate in a reactive solvent may further include an acrylate monomer such as, for example, methyl methacrylate (MMA), ethyl methacrylate (EMA), butyl methacrylate (BMA), or 2-ethyl hexyl methacrylate (2-EHMA), or monomers such as, p-vinyltoluene, α-methyl styrene, diallyl phthalate, or triallyl cyanurate. The additional monomers may improve the solubility and stability of the mixture of reactive solvent, and oligomeric phosphonate in UPET resin. The weight concentration of acrylate monomer incorporated into the styrene, oligomeric phosphonate mixture may be up to about 5%. For example, in some embodiments, the weight concentration of acrylate monomer may be from about 0.1% to about 5%, about 0.5% to about 4%, about 0.75% to about 2% or any range or individual value encompassed by these example ranges.

The step of dissolving the oligomeric phosphonate in a reactive solvent may be carried out immediately before combining with UPET in order to reduce the dissolution time of the oligomeric phosphonate in the UPET resin. Such compositions may include oligomeric phosphonate in a reactive solvent and one or more acrylic monomers. In other embodiments, the step of dissolving the oligomeric phosphonate in reactive solvent may be carried out for a time period of hours, days, or weeks before combining with UPET. In certain embodiments, oligomeric phosphonate that are dissolved in reactive solvent before being combined with UPET may further include one or more acrylic monomers.

In particular embodiments, the oligomeric phosphonate can be used in powder form instead of pellets, which enhances the dissolution time of the oligomeric phosphonate in the UPET resin and reactive solvent mixture. In such embodiments, particle size of the oligomeric phosphonate powder can be from about 50 microns to about 500 microns, and in some embodiments, the powder can have an average particle size of about 75 microns to about 150 microns.

The UPET resins encompassed by the invention include any unsaturated polyester or vinyl ester resins known in the art. For example, UPETs include ortho-resins based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins prepared from isophthalic acid, maleic anhydride or fumaric acid, and glycols, bisphenol-A-fumarates derived from bisphenol-A and fumaric acid, chlorendics prepared from chlorine/bromine containing anhydrides or phenols, and vinyl ester resins which can be prepared from epoxy resins such as, for example, diglycidyl ether of bisphenol-A, epoxies of the phenol-novolac type, or epoxies based on tetrabromobisphenol-A reacted with (meth)acrylic acid or acrylamide monomers. Vinyl ester resins may provide improved hydrolytic resistance and excellent mechanical properties, as well as low styrene emission. In some embodiments, the UPET may be a vinyl ester urethane resin obtained by the esterification of an epoxy resin with an acrylic acid or acrylamide monomers. In some embodiments, the resins described above may be modified to, for example, achieve lower acid number, lower hydroxyl number or anhydride number, or by introducing flexible units in the backbone.

The cobalt containing curing agent may be any cobalt containing curing agent known in the art such as, for example, cobalt octoate, cobalt 2-ethylhexanoate, cobalt naphthenate, cobalt acetylacetonate, and the like, and combinations thereof. In some embodiments, the curing agent may be a transition metal curing agent such as, for example, lead naphthenate, manganese naphthenate, manganese octoate, manganic acetylacetonate, zinc octoate, zinc naphthenate, zinc acetylacetonate, copper acetylacetonate, cupric naphthenate, nickel acetylacetonate, titanyl acetylacetonate, ferric octoate, tin octoate, vanadium(IV) acetylacetonate, vanadium(V) acetylacetonate, and the like or combinations thereof, and in certain embodiments, the cobalt containing curing agents may be combined with one or more transition metal containing curing agent. The curing agent can be present in the resin composition in an amount of about 0.05 mmol per kg of resin or more. For example, the amount of transition metal-containing promoter may be from about 0.05 mmol per kg of resin to about 50 mmol per kg of resin, or about 1.0 mmol per kg of resin to about 20 mmol per kg of resin.

The peroxide component can be any peroxide known in the art. Such peroxides include any organic and inorganic peroxides such as, for example, peroxy carbonates (—OC(O)O—), peroxyesters (—C(O)OO—), diacylperoxides (—C(O)OOC(O)—), dialkylperoxides (—OO—), and the like and combinations thereof. Particular examples of suitable organic peroxides include, but are not limited to, tertiary alkyl hydroperoxides (such as, t-butyl hydroperoxide), other hydroperoxides (such as cumene hydroperoxide), ketone peroxides (such as, for instance, methyl ethyl ketone peroxide, methyl isobutyl ketone peroxide, and acetylacetone peroxide), peroxyesters or peracids (such as t-butyl peresters, benzoyl peroxide, peracetates, and perbenzoates, lauryl peroxide, including (di)peroxyesters), -perethers (such as, peroxy diethyl ether), tertiary peresters or tertiary hydroperoxides, i.e. peroxy compounds having tertiary carbon atoms directly united to an —OO-acyl or —OOH group. Such peroxides may be mixed, i.e. peroxides containing any two of different peroxygen-bearing moieties in one molecule. In case a solid peroxide is being used for the curing, the peroxide is preferably benzoyl peroxide (BPO). In certain embodiments, the peroxide may be selected from the group of ketone peroxides, and in some embodiments, the peroxide may be methyl ethyl ketone peroxide. In certain embodiments the peroxide may be selected from the acetyl acetone peroxide family. These peroxides such as 2,4-Pentanedione Peroxide showed 25-50% higher curing efficiency than conventional MEK peroxides. The peroxide component may be incorporated into the reaction mixture in any amount sufficient to provide adequate activity. For example, in some embodiments, the reaction mixture may include about 0.1 wt. % to about 10 wt. % peroxide component, and in other embodiments, the reaction mixture may include about 0.2 wt. % to about 8 wt. %, about 0.5 wt. % to about 5 wt. %, or any range or individual concentration encompassed by these example ranges.

The co-promoter may be any co-promoter known in the art including, organic amines for example, N,N-dimethylaniline, N,N-dimethylacetoacetamide, N,N-diethylaniline Acetoacetanilide, and N-phenyldiethoanolamine. Other examples include N,N-diisopropylidine-p-toluidine, N,N-dimethyl-p-toluidine, N,N-diisopropylol-p-toluidine, N,N-diethylol-p-toluidine, N-bis(2-hydroxyethyl)-xylidine, ethyl acetoacetate, methyl acetoacetate, and the like and combinations thereof. In particular embodiments, the co-promoter may be N,N-dimethylaniline (DMA) or N,N-dimethylacetoacetamide (DMAA).

The oligomeric phosphonates may include oligophosphonates, random co-oligophosphonates, co-oligo(phosphonate ester)s, or co-oligo(phosphonate carbonate)s, and in certain embodiments, the phosphonate component may have the structures described and claimed in U.S. Pat. Nos. 6,861,499, 7,816,486, 7,645,850, 7,838,604, 8,415,438, 8,389,664, 8,648,163, 8,563,638, 8,779,041, 8,530,044, and U.S. Publication No. 2009/0032770, each of which is hereby incorporated by reference in its entirety.

Such oligomeric phosphonates may include repeating units derived from diaryl alkylphosphonates or diaryl arylphosphonates. For example, in some embodiments, such oligomeric phosphonates include structural units illustrated by Formula I:

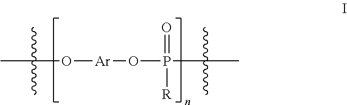

where Ar is an aromatic group and —O—Ar—O— may be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges.

In some embodiments, the oligomeric phosphonates may have a weight average molecular weight (Mw) of about 1,000 g/mole to about 18,000 g/mole as determined by GPC, and in other embodiments, the oligomeric phosphonates may have an Mw of from about 1,000 to about 15,000 g/mole as determined by GPC and calibrated to polystyrene standards. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole. The narrow molecular weight distribution (i.e., Mw/Mn) of such oligomeric phosphonates may be from about 2 to about 7 in some embodiments and from about 2 to about 5 in other embodiments.

In some embodiments, the oligomeric phosphonates may be a random co-oligo(phosphonate carbonate). These random co-oligo(phosphonate carbonate)s may include repeating units derived from at least 20 mole percent high-purity diaryl alkylphosphonate or optionally substituted diaryl alkylphosphonate, one or more diaryl carbonate, and one or more aromatic dihydroxides, wherein the mole percent of the high-purity diaryl alkylphosphonate is based on the total amount of transesterification components, i.e., total diaryl alkylphosphonate and total diaryl carbonate. As indicated by the term “random,” the monomers of the co-oligo(phosphonate carbonate)s of various embodiments are incorporated into the polymer chain randomly. Therefore, the polymer chain may include alternating phosphonate and carbonate monomers linked by an aromatic dihydroxide and/or various segments in which several phosphonate or several carbonate monomers form oligophosphonate or polyphosphonate or oligocarbonate or polycarbonate segments. Additionally, the length of various oligo or polyphosphonate oligo or polycarbonate segments may vary within individual co-oligo(phosphonate carbonate)s.

The phosphonate and carbonate content of the co-oligo(phosphonate carbonate)s may vary among embodiments, and embodiments are not limited by the phosphonate and/or carbonate content or range of phosphonate and/or carbonate content. For example, in some embodiments, the co-oligo(phosphonate carbonate)s may have a phosphorus content, which is indicative of the phosphonate content of from about 1% to about 20% by weight of the total co-oligo(phosphonate carbonate), and in other embodiments, the phosphorous content of the co-oligo(phosphonate carbonate)s of the invention may be from about 2% to about 10% by weight of the total polymer.

The co-oligo(phosphonate carbonate)s of various embodiments exhibit both a high molecular weight and a narrow molecular weight distribution (i.e., low polydispersity). For example, in some embodiments, the co-oligo(phosphonate carbonate)s may have a weight average molecular weight (Mw) of about 1,000 g/mole to about 18,000 g/mole as determined by GPC, and in other embodiments, the oligomeric phosphonates may have an Mw of from about 1,000 to about 15,000 g/mole as determined by GPC. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole. The narrow molecular weight distribution (i.e., Mw/Mn) of such oligomeric phosphonates may be from about 2 to about 7 in some embodiments and from about 2 to about 5 in other embodiments.

In other embodiments, the co-oligo(phosphonate carbonate)s, co-oligo(phosphonate carbonate)s, or co-oligo(phosphonate ester)s, may have structures such as, but not limited to, those structures of Formulae II and III, respectively:

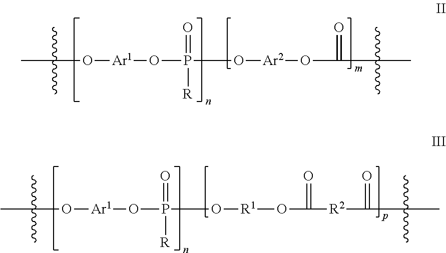

and combinations thereof, where Ar¹, and Ar² are each, independently, an aromatic group and —O—Ar—O— may be derived from a dihydroxy compound having one or more, optionally substituted aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, R¹ and R² are aliphatic or aromatic hydrocarbons, and each m, n, and p can be the same or different and can, independently, be an integer from 1 to about 20, 1 to about 10, or 2 to about 5, or any integer between these ranges. In certain embodiments, each m, n and p are about equal and generally greater than 5 or less than 15.

As indicated by the term “random,” the monomers of the “random co-oligo(phosphonate carbonate)s” or “random co-oligo(phosphonate ester)s” of various embodiments are incorporated into the polymer chain randomly, such that the oligomeric phosphonate chain can include alternating phosphonate and carbonate or ester monomers or short segments in which several phosphonate or carbonate or ester monomers are linked by an aromatic dihydroxide. The length of such segments may vary within individual random co-oligo(phosphonate carbonate)s or co-oligo(phosphonate ester)s.

In particular embodiments, the Ar, Ar¹, and Ar² may be derived from bisphenol A, and R may be a methyl group providing polyphosphonates, oligomeric phosphonates, random and block co-oligo(phosphonate carbonate)s and co-oligo(phosphonate ester)s having reactive end-groups. Such compounds may have structures such as, but not limited to, structures of Formulae IV, V, and VI:

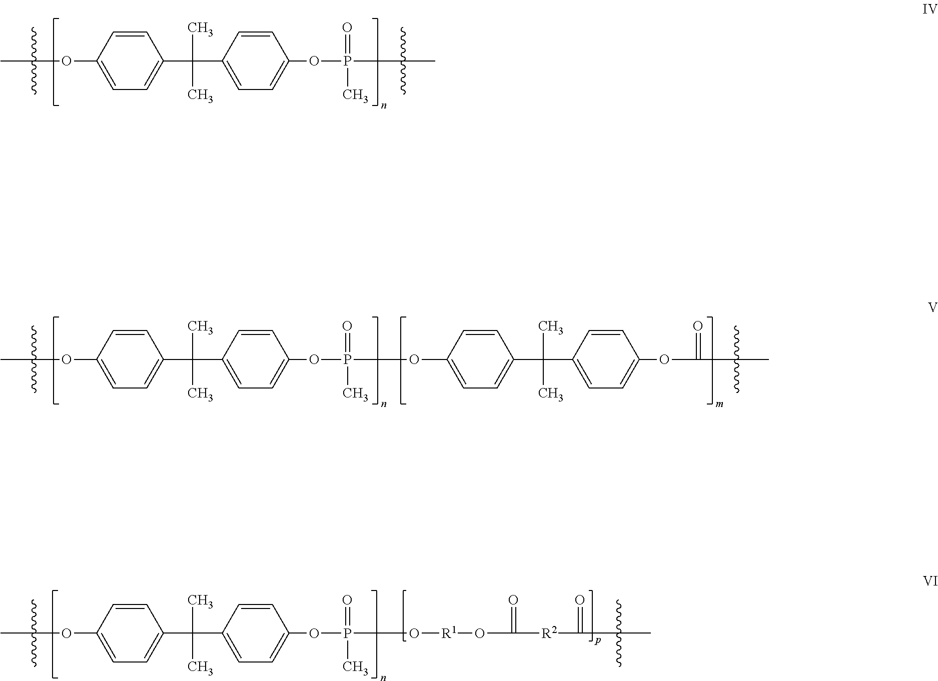

and combinations thereof, where each of m, n, p, and R¹ and R² is defined as described above. Such co-oligo(phosphonate ester)s, or co-oligo(phosphonate carbonate)s may be block co-oligo(phosphonate ester), block co-oligo(phosphonate carbonate) in which each m, n, and p is greater than about 1, and the co-oligomers contain distinct repeating phosphonate and carbonate blocks or phosphonate and ester blocks. In other embodiments, the oligomeric co-oligo(phosphonate ester)s or co-oligo(phosphonate carbonate)s can be random co-oligomers in which each m, n, and p can vary and may be from 1 to about 20, 1 to about 10, or 2 to about 5, where the total of m, n, and p is an integer from 1 to about 20, 1 to about 10, or 2 to about 5, or any integer between these ranges.

In some embodiments, bisphenol A may be the only (i.e., 100%) bisphenol used in the preparation of the phosphonate component. In other embodiments, bisphenol A may make up about 5% to about 90%, about 10% to about 80%, about 20% to about 70%, about 30% to about 60%, about 40% to about 50%, or a value between any of these ranges, with the remainder being another bisphenol such as any one or more of the bisphenols described above.

The phosphorous content of oligomeric phosphonates may be controlled by the molecular weight (MW) of the bisphenol used in the oligomeric phosphonates, polyphosphonates, or co-oligophosphonates. A lower molecular weight bisphenol may produce an oligomeric phosphonate or co-oligophosphonate with a higher phosphorus content. Bisphenols, such as resorcinol, hydroquinone, or a combination thereof or similar low molecular weight bisphenols may be used to make oligomeric phosphonates or polyphosphonates with high phosphorous content. The phosphorus content, expressed in terms of the weight percentage, of the phosphonate oligomers, phosphonates, or co-oligophosphonates may be in the range from about 2% to about 18%, about 4% to about 16%, about 6% to about 14%, about 8% to about 12%, or a value between any of these ranges. In some embodiments, phosphonate oligomers, polyphosphonates, or co-oligophosphonates prepared from bisphenol A or hydroquinone may have phosphorus contents of 10.8% and 18%, respectively. The oligomeric phosphonate co-oligomers have a smaller amount of phosphorus content compared to the phosphonate oligomers and the polyphosphonates. In some embodiments, a bisphenol A-based co-oligophosphonate containing phosphonate and carbonate components wherein the phosphonate component is derived from the methyl diphenylphosphonate at a concentration of 20% compared to the total of the phosphonate and carbonate starting components may have about 2.30% phosphorus, about 2.35% phosphorus, about 2.38% phosphorus, about 2.40% phosphorus, or a range between any of these values, including endpoints.

With particular regard to co-oligo(phosphonate ester)s, co-oligo(phosphonate carbonate)s, block co-oligo(phosphonate ester)s, and block co-oligo(phosphonate carbonate)s, without wishing to be bound by theory, oligomers containing carbonate components, whether as carbonate blocks or randomly arranged carbonate monomers, may provide improved toughness over oligomers derived solely from phosphonates. Such co-oligomers may also provide a higher glass transition temperature, T_{g}, and better heat stability over phosphonate oligomers.

The co-oligo(phosphonate carbonate)s of certain embodiments may be synthesized from at least 20 mole % diaryl alkylphosphonate or optionally substituted diaryl alkylphosphonate, one or more diaryl carbonate, and one or more aromatic dihydroxide, wherein the mole percent of the high-purity diaryl alkylphosphonate is based on the total amount of transesterification components, i.e., total diaryl alkylphosphonate and total diaryl carbonate. Likewise, co-oligo(phosphonate ester)s of certain embodiments may be synthesized from at least 20 mole % diaryl alkylphosphonate or optionally substituted diaryl alkylphosphonate, one or more diaryl esters, and one or more aromatic dihydroxides, wherein the mole percent of the diaryl alkylphosphonate is based on the total amount of transesterification components.

The phosphonate and carbonate content of the oligomeric phosphonates, random or block co-oligo(phosphonate carbonate)s and co-oligo(phosphonate ester)s may vary among embodiments, and embodiments are not limited by the phosphonate and/or carbonate content or range of phosphonate and/or carbonate content. For example, in some embodiments, the co-oligo(phosphonate carbonate)s or co-oligo(phosphonate ester)s may have a phosphorus content of from about 1% to about 12% by weight of the total oligomer. In other embodiments, the phosphorous content may be from about 2% to about 10% by weight of the total oligomer.

In some embodiments, the molecular weight (weight average molecular weight as determined by gel permeation chromatography based on polystyrene calibration) range of the random or block co-oligo(phosphonate ester)s and co-oligo(phosphonate carbonate)s may have a weight average molecular weight (Mw) of about 1,000 g/mole to about 18,000 g/mole as determined by GPC, and in other embodiments, the oligomeric phosphonates may have an Mw of from about 1,000 to about 15,000 g/mole as determined by GPC. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole.

Without wishing to be bound by theory, the relatively high molecular weight and narrow molecular weight distribution of the oligomeric phosphonates of the invention may impart a superior combination of properties. For example, the oligomeric phosphonates of embodiments are extremely flame retardant, exhibit superior hydrolytic stability, and can impart such characteristics on a polymer combined with the oligomeric phosphonates to produce polymer compositions such as those described below. In addition, the oligomeric phosphonates of embodiments generally exhibit an excellent combination of processing characteristics including, for example, good thermal and mechanical properties.

Each phosphonate component described above can be made by any method. In certain embodiments, the phosphonate component may be made using a polycondensation or transesterification method, and in some embodiments, the transesterification catalyst used in such methods may be a non-neutral transesterification catalyst, such as, for example, phosphonium tetraphenylphenolate, metal phenolate, sodium phenolate, sodium or other metal salts of bisphenol A, ammonium phenolate, non-halogen containing transesterification catalysts, and the like, or a combination thereof.

In some embodiments, oligomeric phosphonates can be combined with phosphor containing compounds in the reaction mixture. The oligomeric phosphonates may have a structure including units of Formula I:

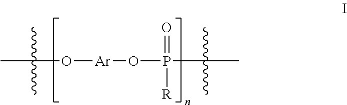

where Ar is an aromatic group and —O—Ar—O— may be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges. In various embodiments, the phosphates may be phosphate flame retardants such as, for example, trimethylphosphate, triethylphosphate, tripropylphosphate, tributylphosphate, tripentylphosphate, trihexylphosphate, tricyclohexylphosphate, triphenylphosphate, tricresylphosphate, trixylenylphosphate, dimethylethylphosphate, methyldibutylphosphate, ethyl dipropylphosphate, and hydroxyphenyldiphenylphosphate. In other embodiments, the phosphates may be oligomeric phosphates.

In such embodiments, the oligomeric phosphonate may be provided in excess of the phosphate or oligomeric phosphate. For example, the ratio of oligomeric phosphonate to phosphate or oligomeric phosphate may be from about 10:1 to about 100:1 or any ratio or range encompassed by this example range. In other embodiments, the reaction mixtures may contain oligomeric phosphonate at a concentration of about 10 wt. % to about 40 wt. %, about 15 wt. % to about 35 wt. %, about 20 wt. % to about 35 wt. %, or any individual concentration or range encompassed by these example ranges, and a phosphate or oligomeric phosphate at a concentration of 0.5 wt. % to about 15 wt. %, about 1 wt. % to about 10 wt. %, about 2 wt. % to about 8 wt. %, or any individual concentration or range encompassed by these example ranges.

In such embodiments, the phosphate or oligomeric phosphate may be added to the reactive solvent oligomeric phosphonate mixture before this mixture is combined with the UPET. The additional phosphate or oligomeric phosphate may increase the overall phosphorous content of the reactive solvent oligomeric phosphonate mixture, while providing sufficient reactive solvent to allow for the complete dissolution of the oligomeric phosphonate. As such, the addition of phosphate or oligomeric phosphate may improve the overall flame retardancy of the cured UPET composition without disrupting the curing efficiency.

In particular embodiments, the method described above may be carried out in the absence of a co-accelerator. In other embodiments, the transition metal-containing promoter may further include a co-accelerator such as, for example, a potassium compound such as potassium oxide, potassium hydroxide, potassium C₆-C₂₀ carboxylate, potassium C₆-C₂₀ carbonate, or potassium C₆-C₂₀ hydrocarbonate. In certain embodiments, potassium carboxylate may be formed in-situ by adding potassium hydroxide to the resin composition. The amount of co-accelerator may vary among embodiments and can be from about 0.001 mmol/kg of resin to 2000 mmol/kg of resin, about 0.1 mmol/kg of resin to 200 mmol/kg of resin, about 1 mmol/kg of resin to about 150 mmol/kg resin, or about 2 to about 40 mmol/kg resin. The molar ratio of the transition metal-containing promoter and the co-accelerator may be from about 40:1 to about 1:3000 or about 25:1 to about 1:100.

In some embodiments, the curing described above may be carried out in the presence of one or more radical inhibitors. Such radical inhibitors include, for example, phenolic compounds, stable radicals like galvinoxyl and N-oxyl based compounds, catechols and/or phenothiazines. Particular examples of radical inhibitors include, but are not limited to, 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, napthoquinone, 1-oxyl-2,2,6,6-tetramethylpiperidine, 1-oxyl-2,2,6,6-tetramethylpiperidine-4-ol (TEMPOL), 1-oxyl-2,2,6,6-tetramethylpiperidine-4-one (TEMPON), 1-oxyl-2,2,6,6-tetramethyl-4-carboxyl-piperidine (4-carboxy-TEMPO), 1-oxyl-2,2,5,5-tetramethylpyrrolidine, 1-oxyl-2,2,5,5-tetramethyl-3-carboxyl pyrrolidine (3-carboxy-PROXYL), aluminium-N-nitrosophenyl hydroxylamine, diethylhydroxylamine, phenothiazine, and/or derivatives or combinations of any of these compounds. The amount of radical inhibitor as used in the curing reactions described above may vary and may be chosen as a first indication of the gel time as is desired to be achieved. For example, the amount of phenolic inhibitor may be from about 0.001 mmol to about 35 mmol per kg of primary resin system or about 0.0001 wt. % to 10 wt. % or about 0.001 wt. % to 1 wt. %, calculated on the total weight of the curing composition.

In certain embodiments, the reaction mixture may further include organic additives such as bases, thiols, dioxo compounds, and the like, and combinations thereof.

In embodiments in which the reaction mixtures contain a base, the base may be any base known in the art. In some embodiments, the base may be a nitrogen-containing base such as a secondary amines- or tertiary amines-containing compound. Examples of such bases include dimethylaniline, dimethyl amine, methyl ethyl amine, methyl ethanolamine, triethylamine, triphenylamine, and the like, and combinations thereof. The base may be incorporated into the reaction mixture at a concentration of about 0.05 wt. % to about 5 wt. %, about 0.1 wt. % to 2 wt. %, about 0.25 wt. % to about 1 wt. % based on the total weight of the reaction mixture, or any individual concentration or range encompassed by these examples. In some embodiments, the molar ratio of the transition metal and the basic functionality of the base can be from about 200:1 to about 1:1500 or about 3:1 to about 1:100.

The dioxo compounds may be any dioxo compositions known in the art; for example, a 1,3-dioxo compound may be acetylacetone. The amount of the 1,3-dioxo compound included in the reaction mixture may be about 0.05 wt. % to about 5 wt. %, about 0.5 wt. % to about 2 wt. % based on the total weight of the reaction mixture, or any individual concentration or range encompassed by these example ranges.

The thiol-containing compounds that can be incorporated into the reaction mixtures may be any thiol-containing compound, and in certain embodiments, the thiol-containing compound may be an aliphatic thiol such as, for example, α-mercapto acetate or β-mercapto propionate, or a derivative or mixture thereof. The amount of thiol-containing compound may vary, and in some embodiments, the molar ratio between the transition metal and the thiol groups of the thiol-containing compound may be about 10:1 to about 1:1500 or about 1:1 to about 1:55.

Although curing may generally be carried out at room temperature (about 20° C. to about 25° C.) in the methods described above, embodiments also include curing at temperatures higher or lower than room temperature. For example, curing can be carried out at temperatures from −20° C. to 200° C., −10° C. to 100° C., 0° C. to 60° C., or any range or individual temperature encompassed by these ranges.

The reaction mixtures described above can be cured completely in less than 60 minutes, and in certain embodiments, complete curing may occur in about 2 minutes to about 30 minutes, about 5 minutes to about 20 minutes, about 7 minutes to about 15 minutes, or any time or time range encompassed by these example ranges. Complete curing results in a non-sticky or non-tacky molded article that can be easily removed from the mold.

Additional embodiments are directed to polymer compositions including UPET and oligomeric phosphonate and cured polymers derived from UPET and oligomeric phosphonate. In some embodiments, the polymer compositions and cured polymer compositions may further include monomeric phosphates or oligomeric phosphate in combination with oligomeric phosphonates. In various embodiments, the compositions may include the concentrations of components described above. For example, the polymer compositions or cured polymer compositions may contain a UPET and one or more oligomeric phosphonates, oligomeric phosphates as described above, or combinations thereof at a concentration of from about 10 wt. % to about 40 wt. %, about 15 wt. % to about 35 wt. %, about 20 wt. % to about 35 wt. %, or any individual value or range encompassed by these example ranges. In other embodiments, the polymer compositions or cured polymer compositions may include a UPET and one or more oligomeric phosphonate as described above at a concentration of from about 10 wt. % to about 40 wt. %, about 15 wt. % to about 35 wt. %, about 20 wt. % to about 35 wt. %, or any individual value or range encompassed by these example ranges, and a phosphate or oligomeric phosphate at a concentration of 0.5 wt. % to about 15 wt. %, about 1 wt. % to about 10 wt. %, about 2 wt. % to about 8 wt. %, or any individual concentration or range encompassed by these example ranges.

In some embodiments, the compositions described above may further include a liquid flame retardant such as liquid phosphates or phosphonates for example, resorcinol bis(diphenyl phosphate) (RDP or Fyroflex®) from ICL, triethyl phosphate (TEP) from Eastman Chemical Company vinylphosphonic acid dimethyl ester (VPAME) from BASF, Ecoflame® P-1045 from Unibrom Corp and diphenyl methylphosphonate (DPP) from FRX Polymers, Inc, and the like and combinations thereof. Such liquid flame retardants can be incorporated into the polymer compositions at any concentration. For example, in various embodiments, polymer compositions may include the liquid flame retardant at a concentration of 0.5 wt. % to about 15 wt. %, about 1 wt. % to about 10 wt. %, about 2 wt. % to about 8 wt. %, or any individual concentration or range encompassed by these example ranges.

The total concentration of oligomeric phosphonate and liquid flame retardant in various embodiments may be less than the amount of oligomeric phosphonate or liquid flame retardant individually required to achieve similar levels of flame retardancy as measured by the UL 94 protocol, total burn time, or other means for measuring flame retardancy. For example, in various embodiments, the polymer compositions may include less than about 30 wt. % total oligomeric phosphonate and liquid flame retardant, and in some embodiments, the concentration of oligomeric phosphonate and liquid flame retardant in the polymer compositions of embodiments may be about 25 wt. % to about 5 wt. %, about 20 wt. % to about 10 wt. % or any individual concentration or range encompassed by these example ranges. The total phosphorous concentration in the polymer compositions of embodiments may be less than polymer compositions exhibiting similar levels of flame retardancy. For example, the phosphorous content of the polymer compositions of embodiments may be less than about 5.0 wt. %, about 0.5 wt. % to about 5.0 wt. %, about 1.0 wt. % to about 4.0 wt. %, about 1.5 wt. % to about 3.0 wt. %, or any individual concentration or range encompassed by these example ranges. The polymer compositions of some embodiments may further include a nitrogen source, and in such embodiments, the nitrogen concentration may be 0.1 wt. % to about 20 wt. %, about 0.5 wt. % to about 15 wt. %, about 1.0 wt. % to about 10 wt. %, about 1.0 wt. % to about 5.0 wt. %, or any individual nitrogen concentration or range encompassed by these example ranges.

The liquid flame retardants described above can be incorporated into the polymer compositions before, during, or after curing. In some embodiments the liquid flame retardants can be first mixed with the phosphonate oligomer before adding to the polymer composition. In other embodiments, the liquid flame retardant may be incorporated into the reaction mixture including oligomeric phosphonate and polyester before introducing the curing agent into the reaction mixture.

In some embodiments the compositions described above may further include solid additive or filler flame retardants containing either phosphorus or nitrogen or both, such as Ammonium Polyphosphate (APP), for example Exolit® AP 422 from Clariant, Melamine Polyphosphate (MPP), for example MPP 200 from JLS Chemical, Aluminum trihydrate (ATH) from Huber Engineered Materials and other organic phosphorus compounds such as Aflammit® PCO900 from Thor Specialties, Inc.

The total concentration of oligomeric phosphonate and solid flame retardant in various embodiments may be less than the amount of oligomeric phosphonate or solid flame retardant individually required to achieve similar levels of flame retardancy as measured by the UL 94 protocol, total burn time, or other means for measuring flame retardancy. For example, in various embodiments, the polymer compositions may include less than about 30 wt. % total oligomeric phosphonate and solid flame retardant, and in some embodiments, the concentration of oligomeric phosphonate and solid flame retardant in the polymer compositions of embodiments may be about 25 wt. % to about 5 wt. %, about 20 wt. % to about 10 wt. % or any individual concentration or range encompassed by these example ranges. The total phosphorous content in the polymer compositions of embodiments may be less than polymer compositions exhibiting similar levels of flame retardancy. For example, the phosphorous content of the polymer compositions of embodiments may be less than about 5.0 wt. %, about 0.5 wt. % to about 5.0 wt. %, about 1.0 wt. % to about 4.0 wt. %, about 1.5 wt. % to about 3.0 wt. %, or any individual concentration or range encompassed by these example ranges. The polymer compositions of some embodiments may further include a nitrogen source, and in such embodiments, the nitrogen concentration may be 0.1 wt. % to about 20 wt. %, about 0.5 wt. % to about 15 wt. %, about 1.0 wt. % to about 10 wt. %, about 1.0 wt. % to about 5.0 wt. %, or any individual nitrogen concentration or range encompassed by these example ranges.

In some embodiments the solid flame retardants can be first mixed with the phosphonate oligomer in a reactive diluent such as styrene before adding to the polymer composition. In other embodiments, the solid flame retardant may be dispersed into the reaction mixture including oligomeric phosphonate and polyester before introducing the curing agent into the reaction mixture.

Polymer compositions described above may exhibit a viscosity as measured by a Brookfield viscometer of less than about 3000 centipoise (cps), and in some embodiments, the viscosity of the polymer compositions of embodiments may be about 2500 cps to about 300 cps, about 2000 cps to about 400 cps, about 1500 cps to about 500 cps, about 1200 cps to about 150 cps, or any individual viscosity or range encompassed by these example ranges. In some embodiments the viscosity of the polymer composition containing the oligomeric phosphonate is reduced from 2200 cps to 700 cps or 1100 to 200 cps by the addition of a liquid flame retardant.

The polymer compositions of the embodiments describe above may be transparent or translucent. Transparent materials have the property of transmitting light without appreciable scattering and therefore objects beyond it are clearly visible. Translucent materials have the property of both transmitting and diffusing light, so objects beyond it are not clearly visible. For example, in some embodiments, the polymer compositions may exhibit a range of light transmittance measured using a spectrophotometer or haze meter of about 3% to about 90%, about 10% to about 90%, about 20% to about 90%, about 30% to about 90%, about 40% to about 90%, about 50% to about 90%, about 55% to about 85%, about 60% to about 80%, about 70% to about 80% or any individual transparency or range encompassed by these example ranges. Samples with light transmission percentages over 80% are considered transparent and below 80% to as low as 3% can be considered translucent. Optical clarity (transparency) is also thickness dependent and will decrease with increasing thickness.

Further embodiments are directed to articles of manufacture containing the polymer compositions and cured polymer compositions described above. For example, in some embodiments, the polymer compositions can be used in closed-mold applications or open-mold applications in the production of cured polymers that can be used in marine applications, chemical anchoring, roofing, construction, relining, pipes, tanks, flooring, windmill blades, decorative laminates (kitchen interiors), aviation and rail applications (window frames, luggage racks/storage areas, interior wall cladding panels, folding tables, etc.), and the like. Such articles of manufacture include objects or structural parts obtained by curing the polymer compositions described above. These objects and structural parts have excellent mechanical properties and excellent flame retardancy.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Preparation of Samples

Unsaturated polyester (UPET) resin used in these examples is an unsaturated polyester casting resin (SIL95 grade), obtained from Interplastic Corporation (Minnesota, US). The oligomeric phosphonate (Nofia® OL5000, FRX Polymers) was used as ground powder (75-150 microns). The organic peroxides 2,4-Pentanedione peroxide (Luperox 224) and MEKP-9H (Norox®) were obtained from Sigma-Aldrich and Syrgis Performance Initiators respectively. Cobalt 2-ethyl hexanoate (12% Cobalt) was obtained from Puritan Products. Dimethylaniline (DMA) and Dimethylacetoacetamide (DMAA) were obtained from Eastman Chemical Company. The flame retardants used in the formulations were obtained from commercial sources; Resorcinol bis(diphenyl phosphate) Fyroflex (RDP) from ICL, Exolit AP 422 from Clariant, Triethyl phosphate (TEP) from Eastman Chemical Company, Melamine Polyphosphate (MPP 200) from JLS Chemical, Aflammit PCO 900 from Thor Specialties, Inc, Vinylphosphonic acid dimethyl ester (VPAME) from BASF, Ecoflame P-1045 from Unibrom Corp ((5-Ethyl-2-methyl-1,3,2-dioxaphosphorinan-5-yl)methyl dimethyl phosphonate P-oxide) and Alumina Trihydrate (ATH) Micral 632 (mean particle diameter 3.5 microns), and translucent grades Onyx Elite® 95 (median particle diameter—65 microns), and Onyx Elite® 300 (median particle diameter—23 microns), from Huber Engineered Materials.

The formulations were prepared by adding Nofia OL5000 phosphonate oligomer, and styrene to UPET resin and mixing until fully dissolved. Depending on the oligomer loading level, the total mixing time for the oligomer to fully dissolve in the resin ranged from 2 to 6 hours. Additional additives, such as co-flame retardant (co-FR) additives were then added in until fully dispersed. Typical mixing time is 2 hours. The catalyst/promoter/co-promoter blend was then mixed into the solution for 60 seconds before pouring into the mold. Gel times were measured at 25° C. and curing is done at 50° C. for 4 hours.

FR test samples (bars) were cast from fluorinated silicone templates (Viton Rubber) as the substrate. The bars were 125 mm×13 mm×3 mm. The formulations are poured into each mold and placed in a 50° C. oven for 4 hours for complete curing.

A UL 94 vertical burn chamber was used for screening of the test samples. The 3 mm thick bars were suspended along the vertical axis and a 2 cm flame is applied to the sample for 10 seconds. The time to self-extinguish after the first (t₁) and second (t₂) exposure was recorded. Additionally, the smoke generation was assessed through visual observations.

Viscosity was measured using a Brookfield Viscometer with LV spindle #4 at 200 rpm at 25° C.

Transparency was assessed by visual observations and by measuring light transmission (%) using a Haze-Gard Plus (BYK Gardner) that conforms to ASTM D-1003,

Standard Test Method for Haze and Luminous Transmittance of Transparent Plastics”.

### Comparative Example 1 and Example 1

Formulations containing 42 wt % unsaturated polyester resin (UPET), 25 wt % oligomeric phosphonate (Nofia OL5000), 25 wt % styrene and 5 wt % RDP (co-FR) were prepared. These were cured using varying combinations of an acetyl acetone peroxide (2,4-Pentanedione peroxide), Cobalt 2-ethylhexanoate as the promoter and an additional co-promoter. FR tests of the cured samples containing this formulation all have less than 10 seconds total burn time (t1+t2). The gel times and transparency of the cured samples are presented in TABLE 1. A gel time of under 10 minutes at 25° C. is desirable.

TABLE 1

| | 12% Cobalt 2- | Peroxide | | Co-promoter | | Gel Time | |
|---|---|---|---|---|---|---|---|
| | ethylhexanoate | Luperox 224 | MEKP-9H | DMA | DMAA | @ 25° C. | |
| Example | (wt %) | (wt %) | (wt %) | (wt %) | (wt %) | (min) | Transparent |
| Comp 1 | 0.05 | 2.0 | — | 0.1 | — | >60 | Yes |
| 1-1 | 0.10 | 2.0 | — | 0.1 | — | 40 | No |
| 1-2 | 0.10 | 2.0 | — | 0.7 | — | 12 | No |
| 1-3 | 0.10 | 2.0 | — | — | 0.1 | >60 | Yes |
| 1-4 | 0.10 | 2.0 | | — | 0.7 | >60 | Yes |
| 1-5 | 0.15 | 2.0 | — | — | 0.5 | 15 | Yes |
| 1-6 | 0.15 | 2.0 | — | — | 0.7 | 8 | Yes |
| 1-7 | 0.15 | — | 2.0 | — | 0.7 | 18 | No |

TABLE 1 shows that clear and transparent samples were obtained when cured with 0.05 wt % Cobalt 2-ethylhexanoate, 2.0 wt % peroxide initiator and 0.1% DMA co-promoter, but the gel times were very long, greater than 60 minutes. Example 1-1 showed a decrease in gel time when the Cobalt concentration was doubled from 0.05 wt % to 0.1 wt %, but with loss of clarity and dark brown color formation. Example 1-2 shows increasing the DMA concentration from 0.1 wt % to 0.7 wt % further reduced the gel time, but with loss of transparency and increased color. In Example 1-3 and 1-4, the transparency was maintained when DMAA was used instead of DMA, but the gel times were still greater than 60 minutes. Examples 1-5 and 1-6 demonstrated that by increasing the Cobalt concentration from 0.10 wt % to 0.15 wt % and using DMAA as the co-promoter instead of DMA, the gel time was reduced without affecting the transparency or color of the system. Example 1-7 shows the replacement of 2,4-Pentanedione peroxide (Luperox 224) with a standard methyl ethyl ketone peroxide (MEKP-9H) catalyst did not result in a gel time of less than 10 minutes, and the clarity and transparency of the system was also not retained.

### Comparative Example 2 and Example 2

Formulations containing unsaturated polyester resin (UPET), oligomeric phosphonate (Nofia OL5000), styrene (20 wt %) and soluble liquid additive co-flame retardants (5 wt %) were prepared. The liquid co-FRs were added to lower the viscosity of the system containing the phosphonate oligomer for easier processing. Samples were cured using the combination in Example 1-6, that is 0.15 wt % Cobalt 2-ethylhexanoate, 2.0 wt % Luperox 224 and 0.7 wt % DMAA co-promoter. The results of burn tests and the transparency of bars prepared from the various formulations are shown in TABLE 2.

TABLE 2

| | Nofia | | | | Additional | | Max | Total | |
|---|---|---|---|---|---|---|---|---|---|
| | OL5000 | RDP | TEP | VPA-ME | Styrene | Viscosity | burn time | burn time | Clear, |
| Example | wt % | wt % | wt % | wt % | wt % | cps | (tmax) (s) | (t1 + t2) (s) | Translucent |
| Comp 2A | 0 | — | — | — | 20 | 225 | >20 | >60 | Yes |
| Comp 2B | 30 | — | — | — | 20 | 2200 | 1 | 1 | Yes |
| 2-1 | 25 | 5 | — | — | 20 | 1180 | 0 | 0 | Yes |
| 2-2 | 25 | — | 5 | — | 20 | 800 | 1 | 1 | Yes |
| 2-3 | 25 | — | — | 5 | 20 | 700 | 0 | 0 | No |

Comparative example 2A shows the viscosity of the neat polyester system is 225 cps, while comparative example 2B shows a significant increase in viscosity to 2200 cps when 30 wt % Nofia OL5000 is added to the polyester resin. Examples 2-1 and 2-2 show a reduction in viscosity by replacing 5 wt % of Nofia OL5000 with liquid co-FR's RDP and TEP while maintaining transparency and passing the burn test. Example 2-3 shows reduced viscosity with VPAME but loss of transparency at 5 wt % loading.

### Comparative Example 3 and Example 3

TABLES 3, 4, and 5 show several formulations containing unsaturated polyester resin (UPET), oligomeric phosphonate (Nofia OL5000), styrene (25 wt %) and various combinations of dispersible solid, nitrogen and/or phosphorus based flame retardant additives. All samples were cured using the combination in Example 1-6, that is 0.15 wt % Cobalt 2-ethylhexanoate, 2.0 wt % Luperox 224 and 0.7 wt % DMAA co-promoter. The results of vertical burn tests of bars prepared from combinations of Nofia OL5000 with MPP 200 are shown in TABLE 3.

TABLE 3

| | Nofia | MPP | Total | Total | Max | Total |
|---|---|---|---|---|---|---|
| | OL5000 | 200 | wt % | wt % | burn time | burn time |
| Example | wt % | wt % | P | N | (tmax) (s) | (t1 + t2) (s) |
| Comp 3A | 25 | 0 | 2.6 | 0 | >40 | >50 |
| Comp 3B | 30 | 0 | 3.1 | 0 | 1 | 0 |
| Comp 3C | 0 | 24 | 3.1 | 10 | >40 | >50 |
| Comp 3D | 0 | 39 | 5.0 | 17 | >40 | 10 |
| Comp 3E | 0 | 47 | 6.1 | 20 | 0 | 0 |
| 3-1 | 23 | 1.0 | 2.6 | 0.4 | 0 | 0 |
| 3-2 | 20 | 3.5 | 2.6 | 1.5 | 2 | 3 |
| 3-3 | 20 | 5.0 | 2.7 | 2.0 | 2 | 2 |
| 3-4 | 11 | 11 | 2.6 | 4.7 | 3 | 4 |
| 3-5 | 8 | 8 | 1.9 | 3.5 | >40 | >50 |

Comparative examples 3A and 3B contain only the neat phosphonate oligomer Nofia OL5000. In Comparative Examples 3C to 3E, burn tests of samples containing only MPP filler showed that greater than 5% P (˜40 wt %) loading is required to achieve a total burn time of <10 seconds compared to neat Nofia OL5000 that passed with 3.1 wt % P (Comp 3B). Examples 3-1 to 3-5 show the synergistic effect of combining MPP and Nofia OL5000, where a tmax<10 sec was obtained at a total loading of <25 wt %, while the samples that contain at minimum 25 wt % of either one of these FRs did not have a tmax of <10 sec. Example 3-1 shows the addition of 0.4% N (1 wt %) loading of MPP 200 significantly reduces burning compared to Comparative Example 3A at the same wt % P loading.

### Comparative Example 4 and Example 4

The results of vertical burn tests of bars prepared from combinations of Nofia OL5000 with AP 422 are shown in TABLE 4. At 2.6 wt % P loading neither sample containing only Nofia OL5000 nor only AP 422 self-extinguished in <10 seconds (tmax). In example 4C even at 5.0 wt % P loading, neat AP 422 samples do not self-extinguish in <10 seconds. However, in combination with Nofia OL5000, Example 4-1 shows a <10 second burn time is achieved with the addition of only 1.5 wt % AP 422 to 20 wt % Nofia OL5000. (total FR loading of 21.5 wt %).

TABLE 4

| | Nofia | | Total | Total | Max | Total |
|---|---|---|---|---|---|---|
| | OL5000 | AP 422 | wt % | wt % | burn time | burn time |
| Example | wt % | wt % | P | N | (tmax) (s) | (t1 + t2) (s) |
| Comp 4A | 25 | 0 | 2.6 | 0 | >40 | >50 |
| Comp 4B | 0 | 8 | 2.6 | 1.1 | >40 | >50 |
| Comp 4C | 0 | 16 | 5.0 | 2.2 | >40 | >50 |
| 4-1 | 20 | 1.5 | 2.6 | 0.2 | 5 | 5 |
| 4-2 | 6 | 6 | 2.6 | 0.9 | >40 | >50 |

### Comparative Example 5 and Example 5

The results of vertical burn tests of bars prepared from combinations of Nofia OL5000 with PCO 900 are shown in TABLE 5. Examples 5-1 and 5-2 are formulations containing combinations of PC 900 and Nofia OL5000. Both combinations show a <10 sec burn time compared to the neat Nofia OL5000 and neat PCO 900 at the same wt % P loading as shown in comparative example as 5A and 5B respectively.

TABLE 5

| | Nofia | PCO | Total FR | Total | Max | Total |
|---|---|---|---|---|---|---|
| | OL5000 | 900 | loading | wt % | burn time | burn time |
| Example | wt % | wt % | Wt % | P | (tmax) (s) | (t1 + t2) (s) |
| Comp 5A | 25 | 0 | 25 | 2.6 | >40 | >50 |
| Comp 5B | 0 | 11 | 11 | 2.6 | >40 | >50 |
| 5-1 | 20 | 2 | 22 | 2.6 | 3 | 4 |
| 5-2 | 7.5 | 7.5 | 15 | 2.6 | 3 | 5 |

### Comparative Example 6 and Example 6

Formulations containing unsaturated polyester resin (UPET), oligomeric phosphonate (Nofia OL5000), styrene (25 wt %) and ATH (Micral 632) were prepared, cured and tested for FR performance. Additional compositions containing mixtures of oligomeric phosphonate (Nofia OL5000) with other fillers (AP 422 and MPP 200) with ATH were also tested. All samples were cured using the combination in Example 1-6, that is 0.15 wt % Cobalt 2-ethylhexanoate, 2.0 wt % Luperox 224 and 0.7 wt % DMAA co-promoter. The combinations of Nofia OL5000 with AP 422 were most effective in reducing the level of ATH compared to Nofia OL5000 with MPP 200 or only Nofia OL5000. In the examples 6-5 to 6-7, the ATH loading that was needed to achieve <10 sec (tmax) burn time was reduced by 50-90% when compared to the neat ATH sample shown in comparative example 6A.

TABLE 6

| | Nofia | | ATH | | Total | Total | Max | Total | |
|---|---|---|---|---|---|---|---|---|---|
| | OL5000 | AP 422 | (Micral 632) | MPP 200 | FR | Filler | burn time | burn time | Transmis- |
| Example | (wt %) | (wt %) | (wt %) | (wt %) | (wt %) | (wt %) | (tmax) (s) | (t1 + t2) (s) | sion >30% |
| Comp 6A | — | — | 50 | — | 50 | 50 | 0 | 0 | No |
| 6-1 | 10 | — | 40 | — | 50 | 40 | 10 | 10 | No |
| 6-2 | 15 | — | 35 | — | 50 | 35 | >40 | >50 | No |
| 6-3 | 20 | — | 30 | — | 50 | 30 | >40 | >50 | No |
| 6-4 | 15 | — | 30 | 5 | 50 | 35 | >40 | >50 | No |
| 6-5 | 15 | 5 | 15 | | 35 | 20 | 2 | 2 | No |
| 6-6 | 15 | 10 | 10 | | 35 | 20 | 0 | 0 | No |
| 6-7 | 15 | 15 | 5 | | 35 | 20 | 1 | 1 | No |

### Comparative Example 7 and Example 7

TABLE 7 shows FR results of formulations containing unsaturated polyester resin (UPET), oligomeric phosphonate (Nofia OL5000), styrene, and ATH grades Onyx Elite (OE) 95 and Onyx Elite (OE) 300 that were selected based on their excellent translucency and also act as smoke suppressants. All samples were cured using the combination in Example 1-6, that is 0.15 wt % Cobalt 2-ethylhexanoate, 2.0 wt % Luperox 224 and 0.7 wt % DMAA co-promoter. As shown in Example 7-4 and 7-5, FR performance of OE300 was significantly better than OE95. Median particle diameter of OE300 is about three times smaller (23 microns) than OE95 (65 microns). The better FR performance of OE300 could be attributed to better dispersion of OE300 in the UPET resin. Comparative examples 7A and 7B maintain transparency but the FR is worse. Examples 7-7 show that at 15 wt % of OE300, Nofia OL5000 can be reduced from 25 wt % to 20 wt % and additional 5% increase in OE300 to 20 wt % total in Example 7-8 show the Nofia OL5000 loading be reduced from 25 wt % to 15 wt % and maintain good FR. Qualitative assessment of smoke generation showed a clear reduction in smoke generation with OE300 at 8 wt % loading and above 10 wt % very low smoke generation was observed.

TABLE 7

| | Nofia | ATH | ATH | | | Max | Total | |
|---|---|---|---|---|---|---|---|---|
| | OL5000 | OE 95 | OE 300 | Styrene | RDP | burn time | burn time | Smoke |
| Example | (wt %) | (wt %) | (wt %) | (wt %) | (wt %) | (tmax) (s) | (t1 + t2) (s) | generation |
| Comp 7A | 25 | — | | 10 | | >50 | >50 | moderate |
| Comp 7B | 20 | | | 25 | 5 | 22 | >50 | moderate |
| 7-1 | 25 | 6 | | 10 | | 25 | >50 | moderate |
| 7-2 | 25 | 8 | | 10 | | 15 | 49 | moderate |
| 7-3 | 25 | 10 | | 10 | | 3 | 8 | low |
| 7-4 | 25 | | 6 | 10 | | 20 | 40 | moderate |
| 7-5 | 25 | | 8 | 10 | | 5 | 5 | low |
| 7-6 | 20 | | 10 | 25 | 5 | 10 | 48 | very low |
| 7-7 | 20 | | 15 | 25 | 5 | 2 | 9 | very low |
| 7-8 | 15 | | 20 | 25 | 5 | 8 | 8 | very low |

### Comparative Example 8 and Example 8

TABLE 8 shows light transmission data of select samples that achieve V0 rating. Examples 8-1 shows a transmission value of 78.5% was obtained for a sample containing only OL5000 and no filler. RDP is a clear FR liquid that is added to reduce viscosity especially when higher loadings of OE filler (>10%) are added. Examples 8-2 to 8-4 containing ATH OE300 loadings from 5 wt % to 20 wt % maintain transmission values greater than 70%. Comparative examples 8A and 8B with ATH Micral 632 and MPP 200 have very low transmission values of less than 15%.

TABLE 8

| | | | | ATH | ATH | | | |
|---|---|---|---|---|---|---|---|---|
| | OL5000 | Styrene | RDP | OE 300 | Mi°ral | AP 422 | MPP 200 | % Transmission |
| Example | (wt %) | (wt %) | (wt %) | (wt %) | 632 (wt %) | (wt %) | (wt %) | @ 3 mm |
| Comp 8-A | 15 | 25 | | | 15 | 5 | | 5.0 |
| Comp 8-B | 12.5 | 25 | | | | | 12.5 | 10.6 |
| 8-1 | 25 | 25 | 5 | | | | | 78.5 |
| 8-2 | 25 | 25 | 5 | 5 | | | | 77.9 |
| 8-3 | 25 | 25 | 5 | 10 | | | | 76.2 |
| 8-4 | 25 | 25 | 5 | 20 | | | | 70.3 |

Table 9 shows additional transmission data of UPET formulations with 0, 20 wt % and 25 wt % Nofia OL5000. Even at 25 wt % loadings, only 5% loss in transmission was observed.

TABLE 9

| | OL 5000 | % Transmission |
|---|---|---|
| Example | (wt %) | @ 4.6 mm |
| 9-1 | 0 | 86.6 |
| 9-2 | 20 | 83.3 |
| 9-3 | 25 | 82.0 |

1. A cured polymer comprising an unsaturated polyester, an oligomeric phosphonate, and a cobalt containing curing agent.

2. The cured polymer of claim 1, wherein the unsaturated polyester is selected from the group consisting of ortho-resins based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins prepared from isophthalic acid, maleic anhydride or fumaric acid, and glycols, bisphenol-A-fumarates derived from bisphenol-A and fumaric acid, chlorendics prepared from chlorine/bromine containing anhydrides or phenols, and vinyl ester resins, vinyl ester which can be prepared from epoxy resins such as, for example, diglycidyl ether of bisphenol-A, epoxies of the phenol-novolac type, or epoxies based on tetrabromobisphenol-A reacted with (meth)acrylic acid or acrylamide monomers

3. The cured polymer of claim 1, wherein the oligomeric phosphonate comprises structural units of Formula I: 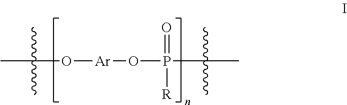
wherein Ar is an aromatic group;
R is C₁₋₂₀ alkyl, C₂₋₂₀ alkene, C₂₋₂₀ alkyne, C₅₋₂₀ cycloalkyl, or C₆₋₂₀ aryl; and
n is an integer from 1 to about 20.

4. The cured polymer of claim 3, wherein —O—Ar—O— is derived from a dihydroxy compound selected from the group consisting of resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof.

5. The cured polymer of claim 1, wherein the oligomeric phosphonate has a weight average molecular weight (Mw) of about 1,000 g/mole to about 18,000 g/mole as determined by GPC.

6. The cured polymer of claim 1, wherein the oligomeric phosphonate has a number average molecular weight (Mn) in such embodiments may be from about 500 g/mole to about 10,000 g/mole.

7. The cured polymer of claim 1, wherein the oligomeric phosphonate has a molecular weight distribution (Mw/Mn) of about 2 to about 7.

8. The cured polymer of claim 1, wherein the oligomeric phosphonate has a phosphorous content of about 2% to about 10% by weight of the total cured polymer.

9. The cured polymer of claim 1, wherein the oligomeric phosphonate is selected from the group consisting of random co-oligo(phosphonate carbonate)s, co-oligo(phosphonate carbonate)s, co-oligo(phosphonate carbonate)s, and co-oligo(phosphonate ester)s.

10. The cured polymer of claim 1, wherein the cobalt containing curing agent is selected from the group consisting of cobalt octoate, cobalt 2-ethylhexanoate, cobalt naphthenate, cobalt acetylacetonate, and combinations thereof.

11. The cured polymer of claim 1, further comprising a transition metal curing agent selected from the group consisting of lead naphthenate, manganese naphthenate, manganese octoate, manganic acetylacetonate, zinc octoate, zinc naphthenate, zinc acetylacetonate, copper acetylacetonate, cupric naphthenate, nickel acetylacetonate, titanyl acetylacetonate, ferric octoate, tin octoate, vanadium(IV) acetylacetonate, vanadium(V) acetylacetonate, and combinations thereof.

12. The cured polymer of claim 1, further comprising an organic peroxide selected from the group consisting of tertiary alkyl hydroperoxides, t-butyl hydroperoxide), hydroperoxides, cumene hydroperoxide, ketone peroxides, methyl ethyl ketone peroxide, methyl isobutyl ketone peroxide, and acetylacetone peroxide, peroxyesters, peracids, t-butyl peresters, benzoyl peroxide, peracetates, perbenzoates, lauryl peroxide, (di)peroxyesters, -perethers, peroxy diethyl ether, tertiary peresters, tertiary hydroperoxides, peroxy compounds having tertiary carbon atoms directly united to an —OO-acyl or —OOH group, and combinations thereof.

13. The cured polymer of claim 1, further comprising a co-promoter selected from the group consisting of N,N-dimethylaniline, N,N-dimethylacetoacetamide, N,N-diethylaniline acetoacetanilide, N-phenyldiethoanolamine, N,N-diisopropylidine-p-toluidine, N,N-dimethyl-p-toluidine, N,N-diisopropylol-p-toluidine, N,N-diethylol-p-toluidine, N-bis(2-hydroxyethyl)-xylidine, ethyl acetoacetate, methyl acetoacetate, and combinations thereof.

14. The cured polymer of claim 1, having a light transmission percentage greater than 80% for a 4.6 mm thickness sample.

15. The cured polymer of claim 1, having a light transmission percentage greater than 70% for a 1 thickness sample.

16. The cured polymer of claim 1, having a light transmission percentage greater than 3% for a 3.0 mm sample.

17. A method for producing a cured polymer comprising:
combining an unsaturated polyester, oligomeric phosphonate, a cobalt curing agent, and co-promoter to form a reaction mixture; and
curing the reaction mixture at about 25° C.

18. The method of claim 17, wherein the gel time is less than 10 minutes.

19. The method of claim 17, wherein the unsaturated polyester is selected from the group consisting of ortho-resins based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins prepared from isophthalic acid, maleic anhydride or fumaric acid, and glycols, bisphenol-A-fumarates derived from bisphenol-A and fumaric acid, chlorendics prepared from chlorine/bromine containing anhydrides or phenols, and vinyl ester resins, vinyl ester which can be prepared from epoxy resins such as, for example, diglycidyl ether of bisphenol-A, epoxies of the phenol-novolac type, or epoxies based on tetrabromobisphenol-A reacted with (meth)acrylic acid or acrylamide monomers

20. The method of claim 17, wherein the oligomeric phosphonate has a weight average molecular weight (Mw) of about 1,000 g/mole to about 18,000 g/mole as determined by GPC.

21. The method of claim 17, wherein the oligomeric phosphonate has a number average molecular weight (Mn) in such embodiments may be from about 500 g/mole to about 10,000 g/mole.

22. The method of claim 17, wherein the oligomeric phosphonate has a molecular weight distribution (Mw/Mn) of about 2 to about 7.

23. The method of claim 17, wherein the oligomeric phosphonate has a phosphorous content of about 2% to about 10% by weight of the total cured polymer.

24. The method of claim 17, wherein the oligomeric phosphonate is selected from the group consisting of random co-oligo(phosphonate carbonate)s, co-oligo(phosphonate carbonate)s, co-oligo(phosphonate carbonate)s, and co-oligo(phosphonate ester)s.

25. The method of claim 17, wherein the cobalt containing curing agent is selected from the group consisting of cobalt octoate, cobalt 2-ethylhexanoate, cobalt naphthenate, cobalt acetylacetonate, and combinations thereof.

26. The method of claim 17, wherein the reaction mixture further comprises a transition metal curing agent selected from the group consisting of lead naphthenate, manganese naphthenate, manganese octoate, manganic acetylacetonate, zinc octoate, zinc naphthenate, zinc acetylacetonate, copper acetylacetonate, cupric naphthenate, nickel acetylacetonate, titanyl acetylacetonate, ferric octoate, tin octoate, vanadium(IV) acetylacetonate, vanadium(V) acetylacetonate, and combinations thereof.

27. The method of claim 17, wherein the reaction mixture further comprises an organic peroxide selected from the group consisting of tertiary alkyl hydroperoxides, t-butyl hydroperoxide), hydroperoxides, cumene hydroperoxide, ketone peroxides, methyl ethyl ketone peroxide, methyl isobutyl ketone peroxide, and acetylacetone peroxide, peroxyesters, peracids, t-butyl peresters, benzoyl peroxide, peracetates, perbenzoates, lauryl peroxide, (di)peroxyesters, -perethers, peroxy diethyl ether, tertiary peresters, tertiary hydroperoxides, peroxy compounds having tertiary carbon atoms directly united to an —OO-acyl or —OOH group, and combinations thereof.

28. The method of claim 17, wherein the reaction mixture further comprises a co-promoter selected from the group consisting of N,N-dimethylaniline, N,N-dimethylacetoacetamide, N,N-diethylaniline acetoacetanilide, N-phenyldiethoanolamine, N,N-diisopropylidine-p-toluidine, N,N-dimethyl-p-toluidine, N,N-diisopropylol-p-toluidine, N,N-diethylol-p-toluidine, N-bis(2-hydroxyethyl)-xylidine, ethyl acetoacetate, methyl acetoacetate, and combinations thereof.

29. The method of claim 17, wherein the reaction mixture further comprises a co-accelerator selected from the group consisting of potassium oxide, potassium hydroxide, potassium C₆-C₂₀ carboxylate, potassium C₆-C₂₀ carbonate, potassium C₆-C₂₀ hydrocarbonate, and combinations thereof.

30. The method of claim 29, wherein the molar ratio of cobalt-containing promoter and the co-accelerator is from about 40:1 to about 1:3000.

31. The method of claim 17, wherein potassium carboxylate is formed in-situ.

32. A composition comprising unsaturated polyester, oligomeric phosphonate, and liquid flame retardant.

33. The composition of claim 32, wherein the liquid flame retardant is selected from the group consisting of resorcinol bis(diphenyl phosphate), triethyl phosphate (TEP), vinylphosphonic acid dimethyl ester (VPAME), low molecular weight liquid phosphonates, (5-Ethyl-2-methyl-1,3,2-dioxaphosphorinan-5-yl)methyl dimethyl phosphonate P-oxide, and diphenyl methylphosphonate (DPP), and combinations thereof.

34. The composition of claim 32, wherein the liquid flame retardant has a concentration of 0.5 wt. % to about 15 wt. %.

35. The composition of claim 32, having a light transmission percentage greater than 80% for a 3 mm thickness sample.

36. The composition of claim 32, having a light transmission percentage greater than 70% for a 3 mm thickness sample.

37. The composition of claim 32, having a light transmission percentage greater than 3% for a 3 mm thickness sample.

38. A composition comprising an unsaturated polyester, oligomeric phosphonate, and filler flame retardant.

39. The composition of claim 38, wherein the filler flame retardants is selected from the group consisting of Ammonium Polyphosphate (APP), Melamine Polyphosphate (MPP), Aluminum trihydrate (ATH), Aflammit® PCO900 from Thor Specialties, Inc., and combinations thereof.

40. The composition of claim 38, wherein the filler flame retardant comprises less than 20% of the composition.

41. The composition of claim 38, having a light transmission percentage greater than 70% for a 3 mm thickness sample.
